(19) United States
(12) Patent Application Publication
(10) Pub. No.: US 2007/0076553 A1
(43) Pub. Date: Apr. 5, 2007

(54) Apparatus for reading and/or writing optical recording media

(76) Inventor: Christian Buchler, Villingen-Schwenningen (DE)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(21) Appl. No.: 10/556,832

(22) PCT Filed: May 14, 2004
(86) PCT No.: PCT/EP04/05198

§ 371 Date: Nov. 16, 2006

(30) Foreign Application Priority Data
May 16, 2003 (DE) 103 22 424.4

(51) Int. Cl. G11B 7/00; G11B 7/085

(52) U.S. Cl. 369/53.23; 369/44.41; 369/30.13

(57) ABSTRACT

Methods and apparatuses for controlling optical storage appliances which allow a signal to be obtained even in areas of the recording media in which there is no contrast, whose phase angle with respect to a tracking error signal indicates the movement direction of an actuator relative to the tracks and the track type. A weighting factor is set from the focus error signals from the main and secondary scanning beam, and a suitable track type signal is obtained.

The invention relates to control methods and apparatuses for track counting in appliances for reading from and writing to optical storage media, in particular obtaining a signal whose phase angle with respect to a tracking error signal indicates the movement direction of one actuator relative to the tracks.

Already known solutions for identification of the movement direction and setting of the track type are predicated on there being a contrast difference between tracks of the “groove” Type G and tracks of the “land” Type L. A mirror signal or a radial contrast signal is used, which allows track counting or determination of the track type relative to a tracking error signal. These signals are available, however, only when there is a contrast difference between G and L. If there is no such contrast difference, for example at unrecorded positions on optical storage media, or no such contrast difference can be evaluated, then these already known solutions do not allow direction identification.

One object of the invention is to describe arrangements and methods which make it possible, even on optical storage media without any contrast between G and L, using the differential focus method to identify the direction of track jumps or the type of tracks currently being crossed.

According to the invention, use is made of the fact that focus error signals include both a component which reflects the vertical distance of the objective lens from the information layer and a focus offset component, which depends on the type and on the position of the respective track being scanned. Use is also made of the fact that, with suitable weighting, the difference between the secondary beam error signal and the main beam error signal contains only the focus offset component which is dependent on the horizontal position of the scanning beams, while those focus error components which are dependent on the vertical distance actually cancel one another out in the subtraction process. Finally, use is made of the fact that a focus offset component DFO determined in this way has a maximum positive or negative amplitude at the track centers, and has zero crossings at the boundaries between G and L. The signal DFO thus has similar characteristics to the abovementioned mirror signals or radial contrast signals, and, like them, can be used as a track type signal for track counting.

The invention proposes that signals which are required to carry out the differential focus method are also used for generation of a land groove detection signal in an appliance for reading from and/or writing to optical recording media. This has the advantage that no hardware is required in addition to that for the differential focus method, but only a number of logic elements for evaluation of the signals.

An adjustment method according to the invention also comprises that the optical recording medium be scanned with the objective lens being deflected in the focusing direction in order to produce a track type signal; the measurement of two measurement signals which are formed differently, and include details about the distance between the objective lens and the recording medium and about the position of the scanning beam relative to the tracks on the recording medium; the evaluation of the measurement signals and adjustment of branch weights as a function of this; and the formation of the track type signal by combination of error signals multiplied by different branch weights.

In other words, the invention describes methods and apparatuses for controlling optical storage appliances, which make it possible to obtain (even in low-contrast areas of the recording media) a signal whose phase angle with respect to a tracking error signal indicates the movement direction of an actuator relative to the tracks, and the track type. The focus error signals from the main and secondary scanning beams are used to set a weighting factor, and to obtain a suitable track type signal.

The present invention will be explained in more detail in the following text using preferred exemplary embodiments and with reference to the attached drawings.

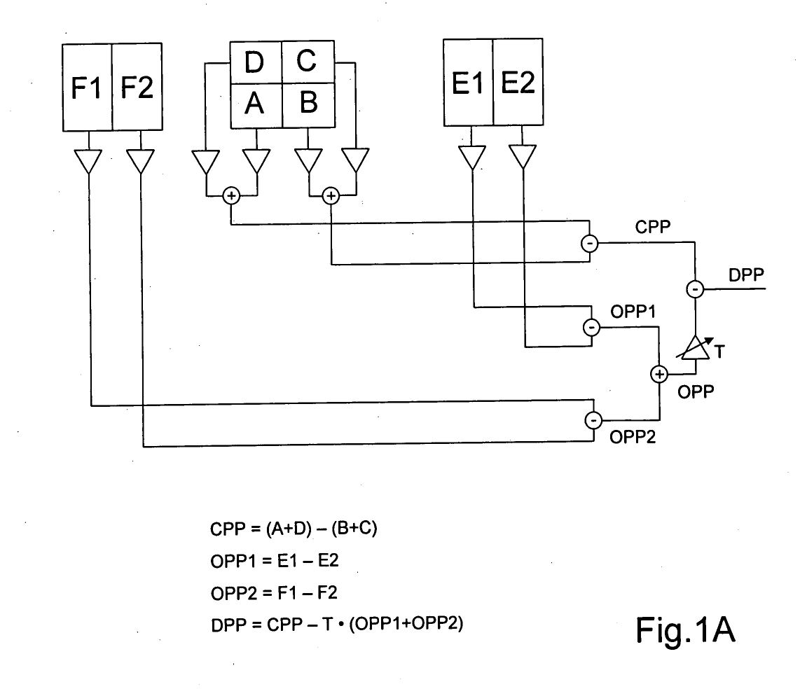

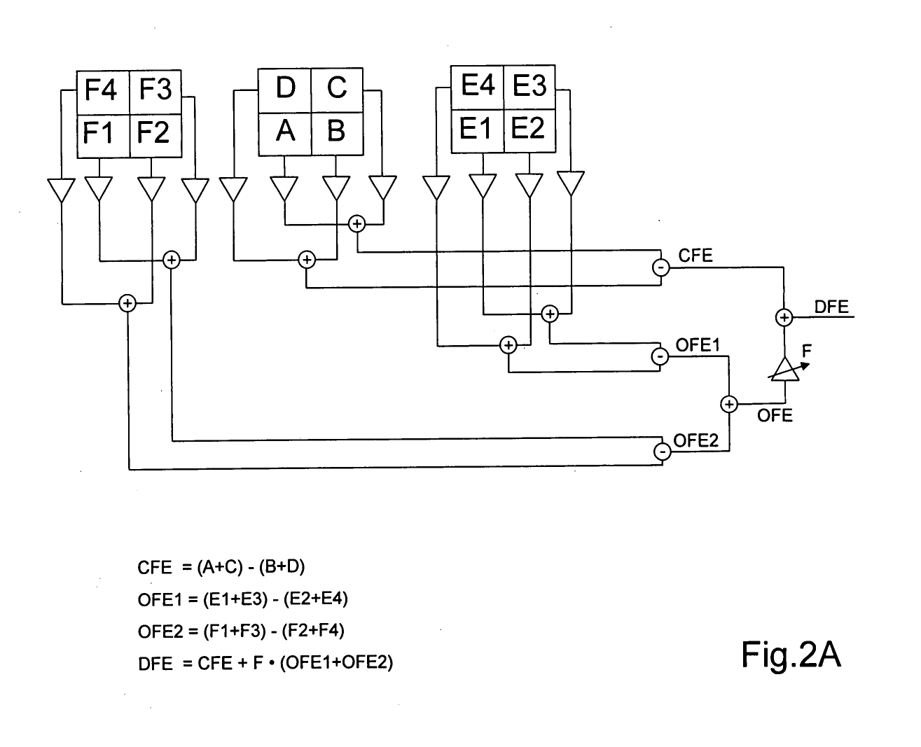

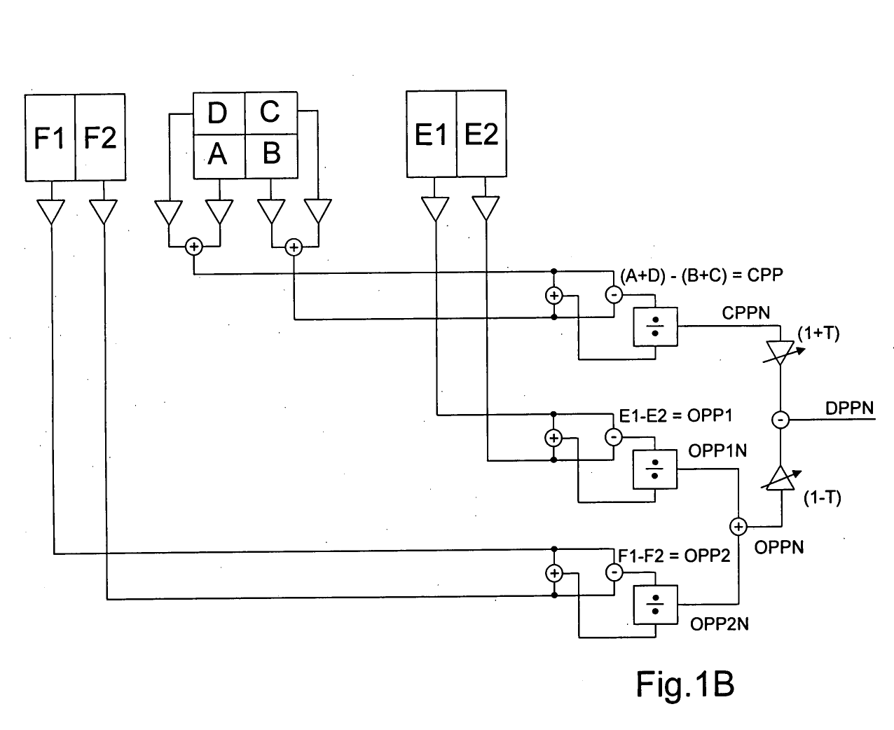

FIG. 1A shows an arrangement according to the prior art for obtaining a tracking error signal DPP using the differential push-pull method.

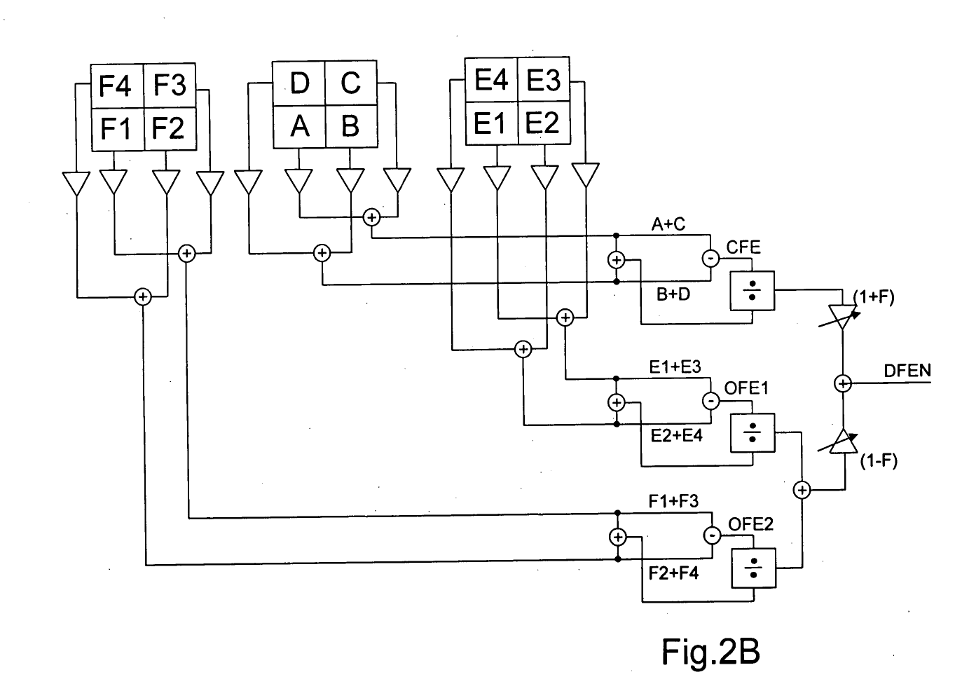

FIG. 2A shows an arrangement according to the prior art for obtaining a differential focus error signal DFE.

FIG. 1B shows an arrangement for obtaining a normalized tracking error signal DPPN with the two signal elements CPPN, OPPN being normalized and weighted.

FIG. 2B shows an arrangement for obtaining a normalized differential focus error signal DFEN with the two signal elements CFEN, OFEN being normalized and weighted.

FIG. 3 shows the design of an optical scanner.

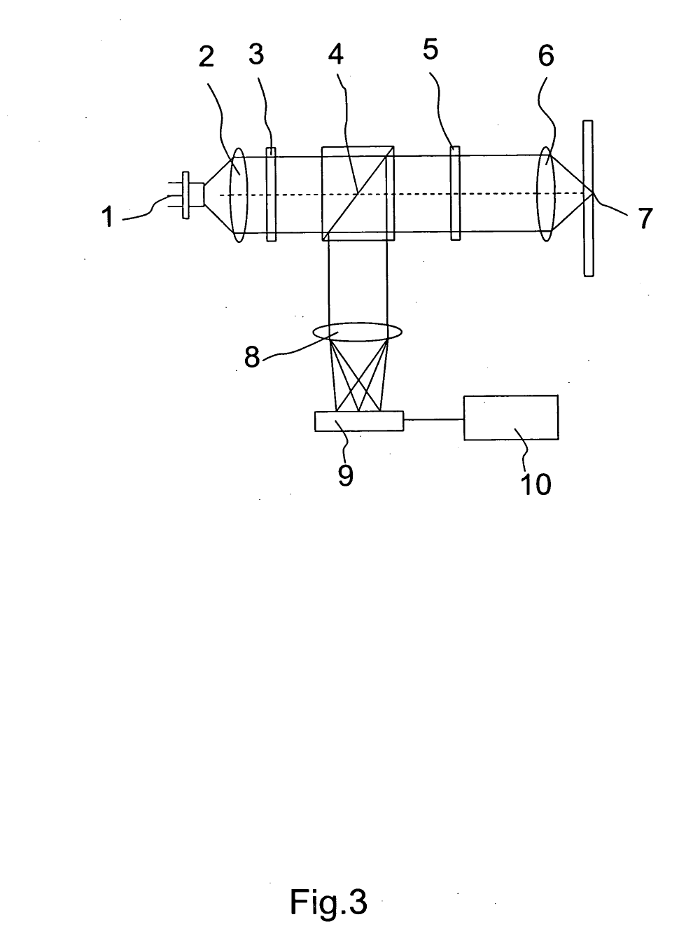

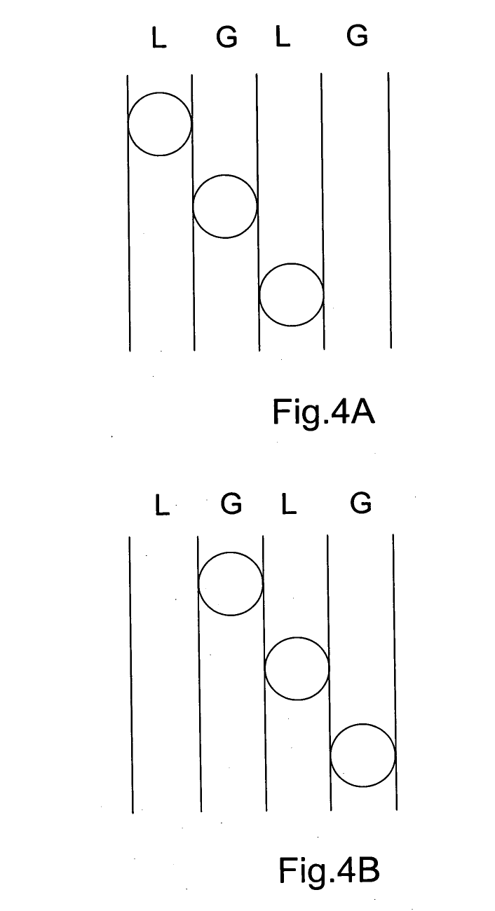

FIG. 4A shows, schematically, an arrangement composed of tracks and scanning beams, in which the main scanning beam strikes the center of a track G.

FIG. 4B shows, schematically, an arrangement composed of tracks and scanning beams, in which the main scanning beam strikes the center of an adjacent track L.

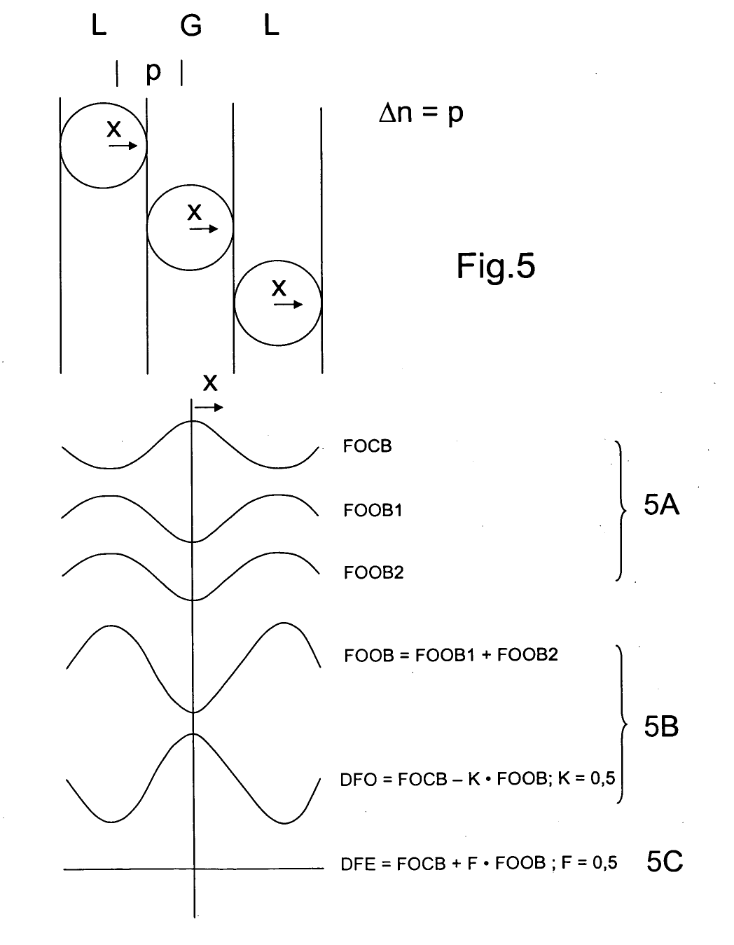

FIG. 5 shows the same arrangement as in FIG. 4A, together with profiles of the components which occur during horizontal movement and are dependent on the focus error.

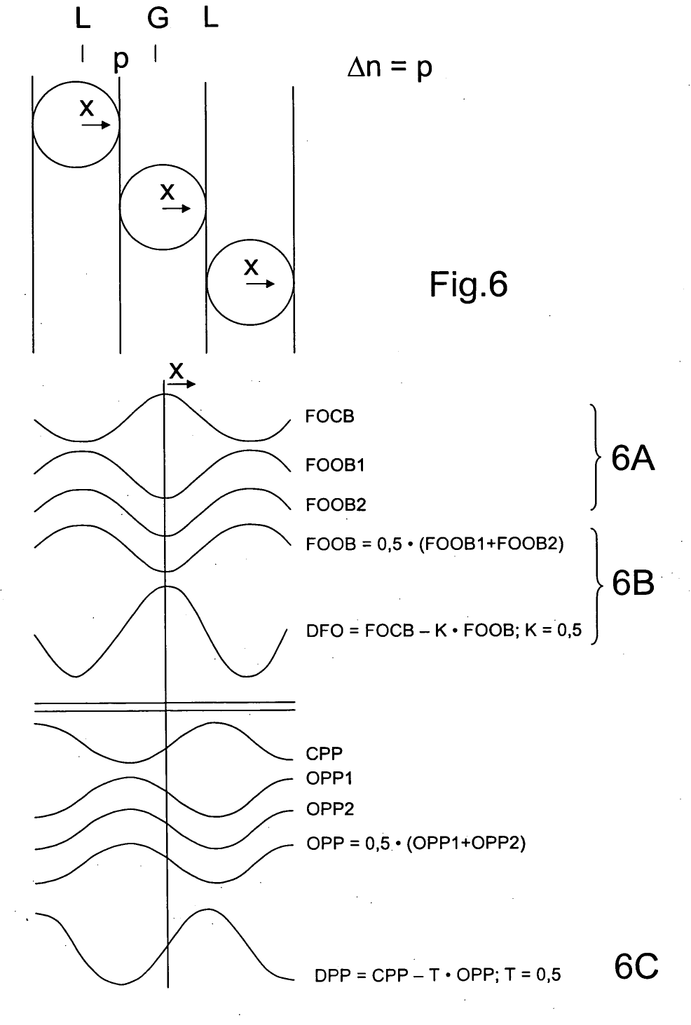

FIG. 6 shows the same arrangement as in FIG. 4A, together with profiles of the signals which are used for determination of the DFO and the DPP, for an assumed scanning distance Δn=p.

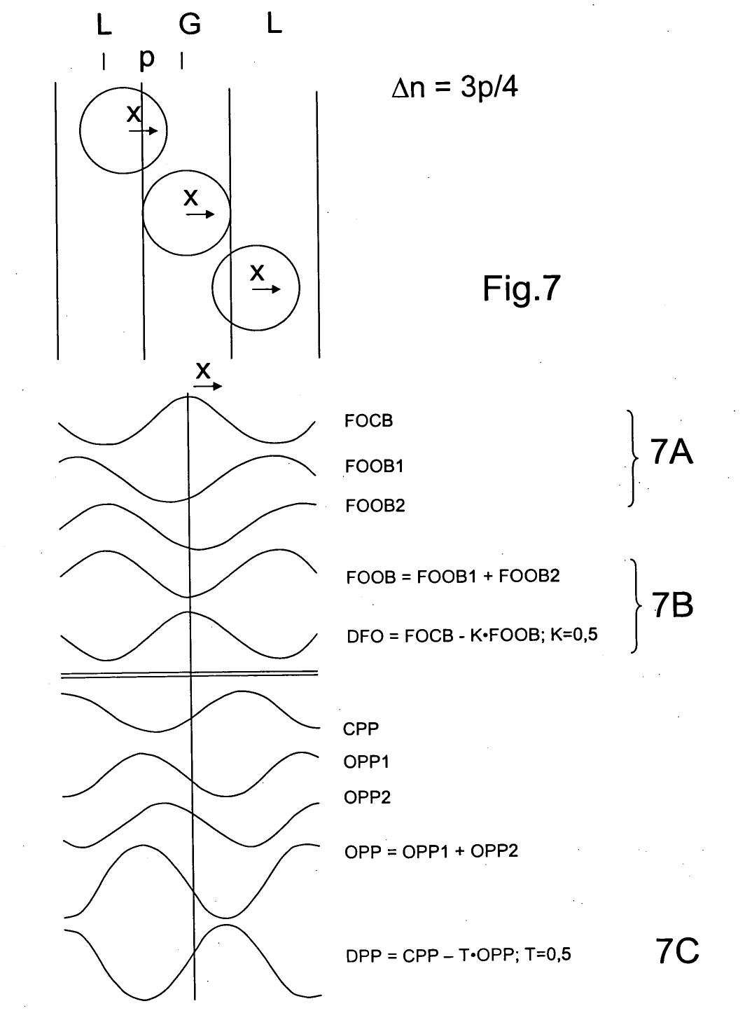

FIG. 7 shows the same for the scanning distance Δn=3p/4.

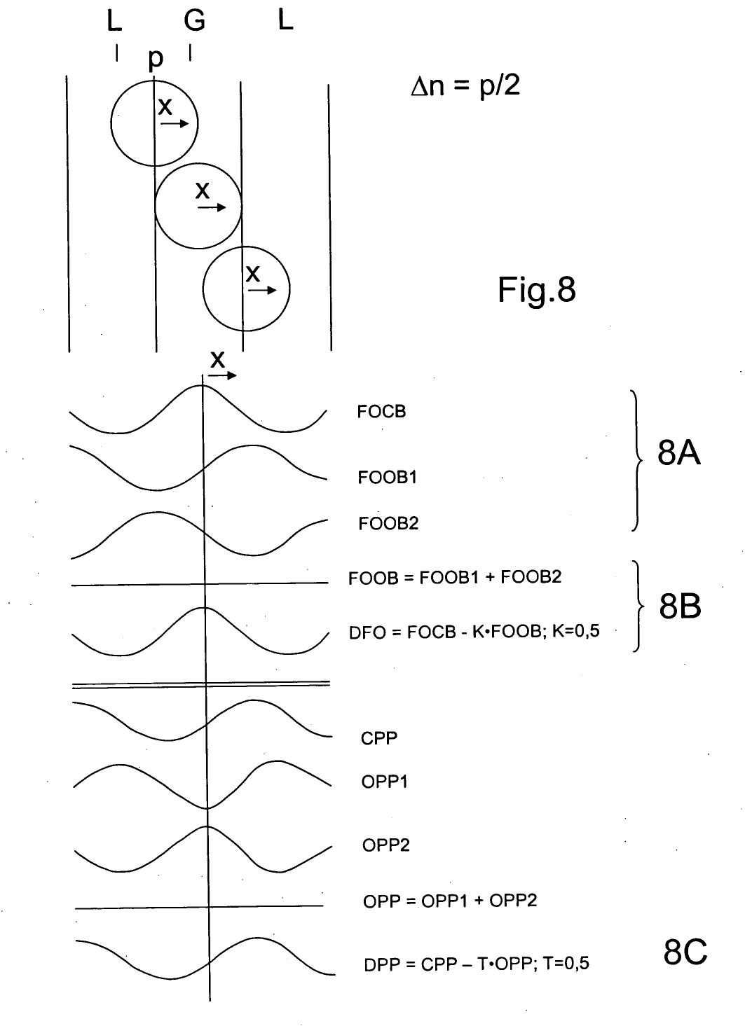

FIG. 8 shows the same for the scanning distance Δn=p/2.

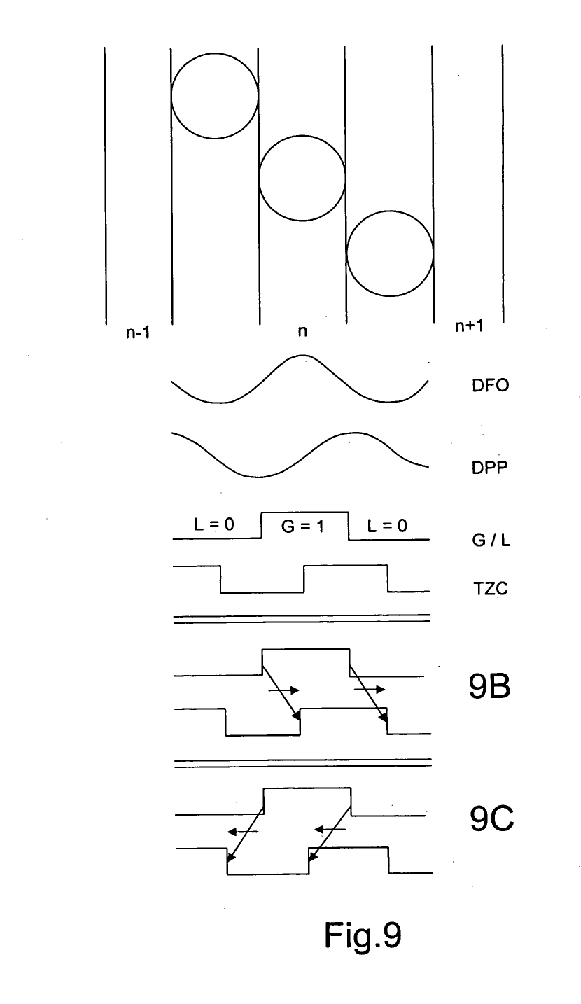

FIG. 9 shows movement direction identification from the DFO and DPP signals.

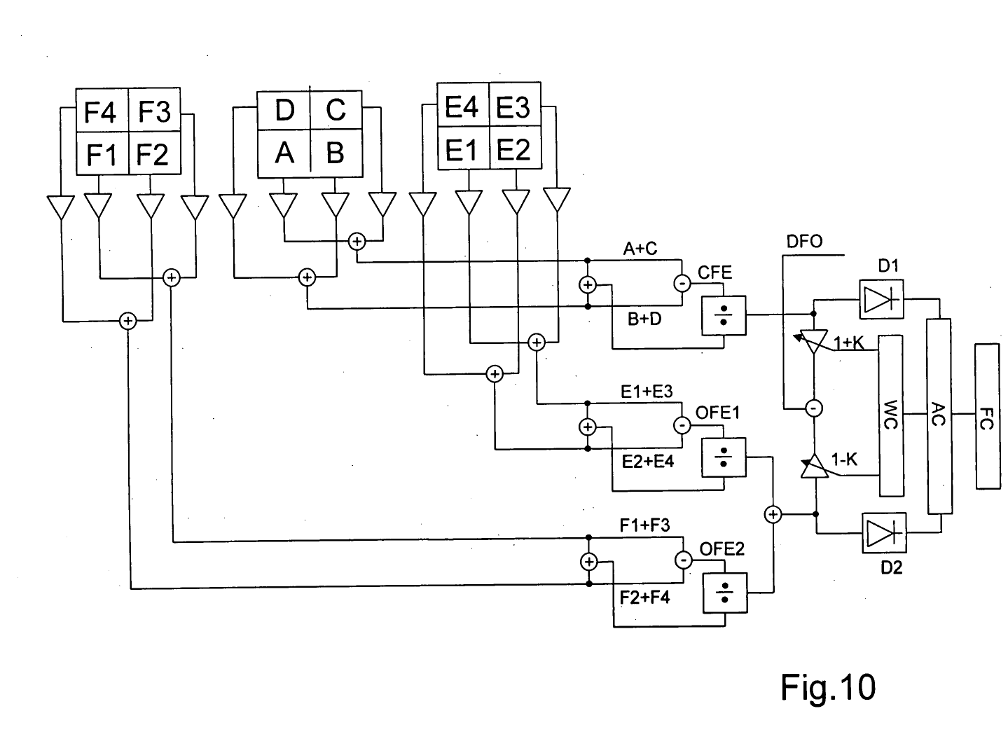

FIG. 10 shows the block diagram of a first arrangement for obtaining a differential focus offset signal DFO.

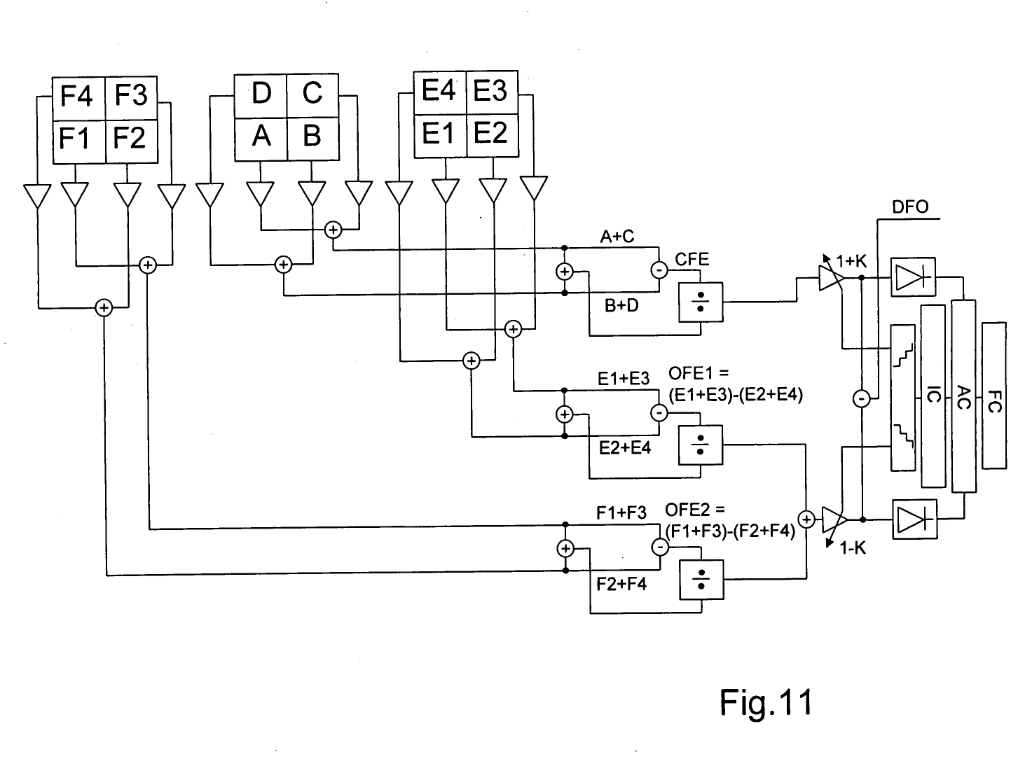

FIG. 11 shows the block diagram of a further arrangement for obtaining a differential focus offset signal DFO.

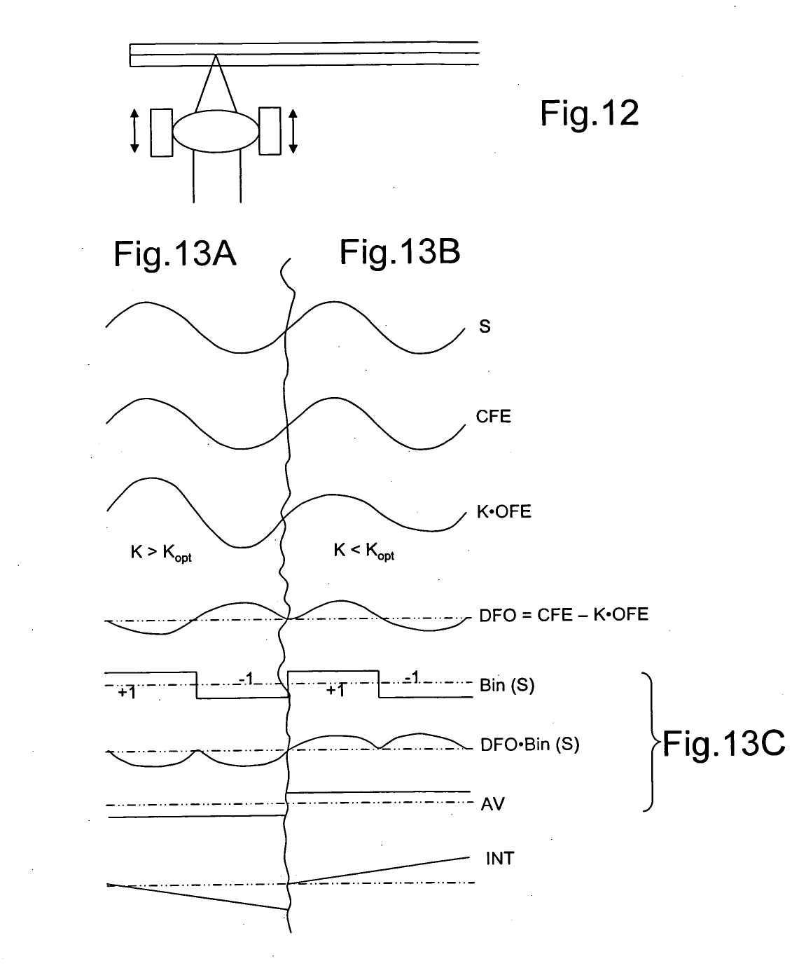

FIG. 12 shows, schematically, an arrangement comprising an actuator, objective lens, scanning beam and storage medium.

FIG. 13 shows signal profiles in the situations in which the weighting factor K is too small or too large.

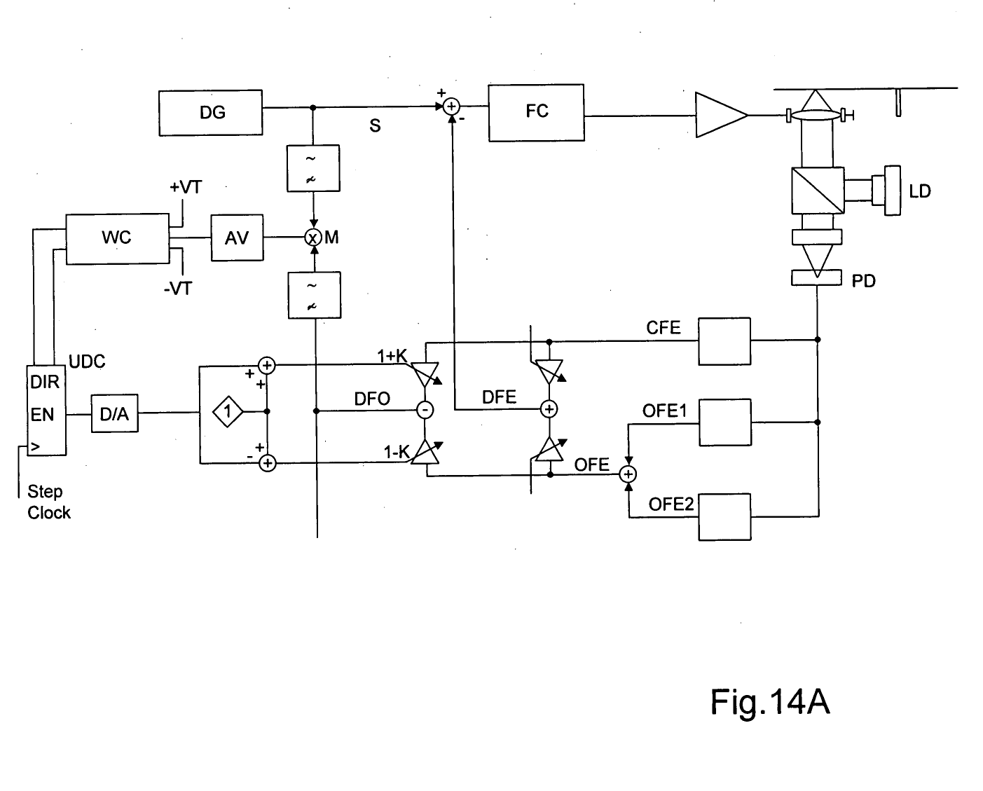

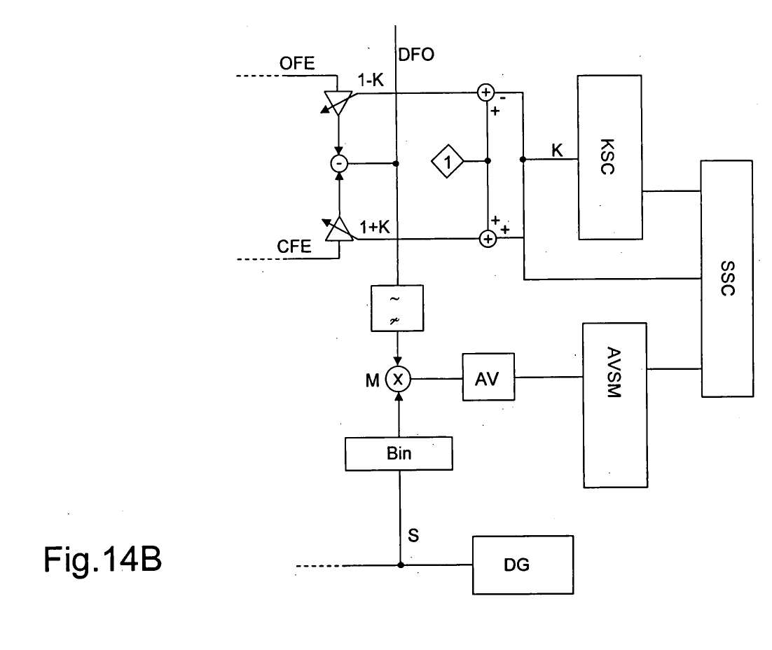

FIGS. 14A, 14B, 15 and 16 show block diagrams of further arrangements for obtaining a differential focus offset signal DFO.

FIG. 1A shows an arrangement based on the so-called differential push-pull method DPP, a widely used method for formation of a tracking error signal. The DPP method uses three beams to scan the optical storage medium. The aim of the DPP method is to form a tracking error signal DPP whose offset is not dependent on the position of the objective lens relative to the optical axis of the scanner.

FIG. 2A shows an arrangement based on the already known so-called differential focus method, which is also referred to as the differential astigmatism method and can be used whenever the photodetector that is used is designed as a four-quadrant detector for both the main beam and the secondary beams. This allows a focus error signal to be formed not only for the secondary beams but also for the main beam. An improved differential focus error signal DFE is formed by the addition of the focus error signal components of the main beam and the signal components of the secondary beams, with the components of the secondary beams being weighted on the basis of their intensities with respect to the main beam.

Both the tracking error components and the focus error components of the main beam and of the secondary beam components are advantageously each normalized by means of their sum component. This is illustrated in FIG. 1B for a normalized differential push-pull signal DPPN and in FIG. 2B for a normalized differential focus error signal DFEN. Normalization of this type is always assumed in the following text, and will no longer be mentioned explicitly. Irrespective of the normalization, the weighting between the main and secondary beam error signals can be carried out in only one signal branch, as shown in FIGS. 1A and 2A, respectively, with the weighting factors T and F shown; or in both signal branches as in FIGS. 1B and 2B, respectively, with the weighting factors 1+T, 1−T and 1+F, 1−F.

The following text is based only on the assumption of the DFE method.

The scanning beam of an optical scanner (see FIG. 3) comprises three beams when using the differential focus method. In order to achieve this splitting into three beams, an optical grating 3 is inserted in the beam path from the light source 1. The main beam or the so-called zero-order beam, which reads the information to be scanned on a track on an optical storage medium, normally contains the greatest proportion, for example 80-90%, of the light information. The two secondary beams or±1st order beams each contain the remaining approximately 5-10% of the total light intensity. In this case, for simplicity, it is assumed that the light energy in the higher diffraction orders of the grating is zero.

The optical grating is designed such that the imaging of the two secondary beams for media which are written to on groove and land is actually in the center of the adjacent tracks of type L or, in the case of media which are written to only in grooves, is actually in the area between two tracks alongside the track of type G which is read by the main beam. Since the secondary beams and the main beam can be optically separated from one another, the positions of their images on the storage medium and on the detector are separated from one another. When the medium rotates, then one of the secondary beams occurs before the main scanning beam in the reading direction, and the other secondary beam occurs behind the main scanning beam.

The reflecting beams pass through an astigmatically acting optical component, for example a cylindrical lens, on the return path to the photodetector. The cylindrical lens produces two focus points, which differ from one another when seen in the x and y directions.

A focus error signal can be produced from each of the scanning beams, and is dependent on the position of the beam relative to the track scanned by it. The focus error signal of each respective scanning beam in this case contains mainly a component which indicates the vertical distance between the objective lens and the information layer on the optical storage medium. It additionally contains a focus offset component which is independent of the vertical distance and depends only on the type of track being scanned in each case. This focus offset component thus indicates the dependency of the horizontal position of the scanning beams on the tracks. The amplitude of this offset component is dependent on the geometry of the tracks, for example being described by track width, track separation, or the track depth of G and L.

As already stated above and illustrated in FIG. 4A, the optical grating is typically adjusted such that the secondary scanning beams actually scan the center of an adjacent track L when the main scanning beam is recording the center of one track G. If as a consequence of a shift of the objective lens with respect to the tracks on the optical storage medium the main scanning beam actually scans the center of an adjacent track L, the secondary scanning beams are each actually located on the center of a track G, as shown in FIG. 4B. The secondary scanning beams are accordingly always in the complementary track position with respect to the track position of the main scanning beam. Since the focus offset components of the main scanning beam and of the secondary scanning beams as mentioned above have a different mathematical sign to one another depending on the track type, these focus offset components cancel one another out in the addition process provided that the secondary beam error signal is correctly weighted with respect to the main beam error signal, while the focus error components are added to one another.

In order to allow a track jump to be controlled, a way should be found to allow determination of the direction of the track jump (to be more precise the direction of the movement of the objective lens with respect to the tracks) and the number of tracks crossed, as well as the track type (G or L). Direction-dependent track counting is thus possible which, together with groove-land identification, allows reliable track jumping and reliable closing of the tracking control loop.

As already mentioned above, the secondary beams (in the case of an appropriate angular position of the optical. grating) are normally in the complementary track position with respect to the track position of the main scanning beam. This is shown in FIG. 5A. If the objective lens is moved in the horizontal direction x with respect to the tracks on the optical storage medium, then the main scanning beam is, for example, located at a specific time in such a way that it is actually scanning the center of an adjacent track L. In this case, the secondary scanning beams are actually in each case located on the center of a track G. At these times, the typical focus-offset-dependent component FOCB which occurs for the adjacent tracks L acts on the main scanning beam, while the typical focus-offset-dependent components FOOB1, FOOB2 which act on the scanned tracks G act on the secondary scanning beams. In addition, the focus-error-dependent component acts equally on all three scanning beams, that is to say one component as a function of the vertical distance error. This is not shown in FIGS. 5A-C since, in this case, all the figure shows is the focus-offset-dependent component caused by the horizontal movement of the scanning beams.

Since the horizontal scanning position of the three beams can change only jointly, the focus offset components at the same time change as a function of the instantaneous track position.

In order to obtain the focus offset components which occur during movement of the scanning beams in the horizontal direction, the components FOOB1, FOOB2 are first of all added to one another to form a secondary beam error signal FOOB, and are then subtracted from the main beam error signal FOCB using a weighting which can be predetermined.

The focus offset components in this case reinforce one another as shown in FIG. 5B provided that the weightings are set correctly, while the focus error components, which are dependent on the vertical distance, actually cancel one another out.

FIG. 5C also shows how the signals of the secondary beams and of the main beam are added to one another with a weighting F in order to form the differential focus error signal DFE, in which case the focus-offset-dependent components cancel one another out, in a compensating form, in this case, when the weighting F is set correctly.

Normally, the beam separation An between the main and secondary beams is set at Δn=p, as shown in FIG. 5. In this case, p is defined as the distance between the center of the track G and the center of the adjacent track L. In contrast to this, it is also possible to vary the distance Δn within sensible limits. FIGS. 6A-6C, FIGS. 7A-7C and FIGS. 8A-8C show the resultant focus-offset-dependent components DFO in each case in the figure elements A and B as well as the formation of the tracking error signal DPP, in the respective figure elements C for different beam separations Δn. The theoretical limit for the value of Δn is in the range 0<Δn<2p, although the limit which can be used in practice is in the range p/2<Δn<3p/2, since the phase of the secondary beam components FOOB and OPP is inverted outside this limit which can be used in practice.

The focus-offset-dependent components of the respective scanning beam typically have a maximum amplitude at the respective track centers of L or G, while they have a zero crossing at the boundaries between G and L. The signal DFO which is formed by calculation of the focus-offset-dependent components of the respective scanning beams has characteristics which are similar to those of the so-called mirror signal or those of the radial contrast signal. The mirror signal or the radial contrast signal is, however, available only when the optical characteristics of the optical recording medium provide a contrast difference between G and L, while the focus-offset-dependent component in the DFE signal can be evaluated even without any contrast difference.

In the same way as the mirror signal or the radial contrast signal, the focus-offset-dependent component relative to a tracking error signal can be used for track counting or for determination of the track type.

In this case, the polarity of the focus-offset-dependent component indicates the track type which is currently being scanned. The direction of the movement of the objective lens with respect to the tracks as well as the number of tracks crossed and the track type that is being scanned at that time can be determined from the phase between the focus-offset-dependent component and a tracking error signal, for example PP or DPP. FIG. 9 shows, once again for the location x, a differential focus offset signal DFO, a differential push-pull signal DPP, a track type signal G/L formed by digitization from DFO and a track zero cross signal TZC formed from DPP. Figure element 9B shows that a movement of the scanning beams from left to right can be identified by there being identical flanks in the TZC signal on rising or falling flanks in the G/L signal. The figure element 9C shows the corresponding situation for a movement from right to left.

As already mentioned above, this focus offset component is obtained by first of all adding the secondary beam error signals to one another and then by subtraction from the main beam error signal using a weighting which can be predetermined. The weighting factor which leads to compensation for the focus-error-dependent component must be determined in a suitable manner for this purpose.

A first method comprises the amplitudes of the focus error components of the secondary beams being determined as a first measurement signal and the amplitude of the focus error component of the main beam being determined as a second measurement signal when passing through the focus point, so-called “focus ramping”, and by the weighting factor being calculated, and thus set, by evaluation of the amplitudes, such that the focus error contributions actually cancel one another out after the subtraction process.

In a first step, the objective lens is moved in such a way that the scanning beams are moved through the focus point on the optical storage medium (focus ramping). During this process, as is shown in FIG. 10, the amplitude of the sum of the secondary beam error signals is determined with the aid of a first peak value detector D1, and that of the main beam error signal is determined with the aid of a second peak value detector D2. For the evaluation process, the weighting calculation compares the amplitudes in an amplitude comparison unit AC, and uses this to calculate a weighting factor in a weighting calculation unit WC. The focus controller FC is connected to the amplitude comparison unit AC. The sum of the secondary beam error signals is then subtracted from the main beam signal using the weighting factor K that has been determined. This is based on the assumption that the weighting factor can be calculated from the amplitudes.

An alternative method, shown in FIG. 11, comprises the amplitudes of the weighted main and secondary beam error signals being measured as a first and a second measurement signal, respectively, and, when the amplitude comparison unit AC finds a difference in the evaluation process, the weighting factor of the weaker signal being increased, and/or that of the stronger signal being reduced when the amplitude comparison unit AC finds a difference in the evaluation process. This can be done by means of an iterative process which includes two or more focusing runs and is ended by an iteration step controller IC when the difference between the amplitudes falls below a predetermined value.

The two methods described above are dependent on the objective lens in each case being moved once or more through the focus point. This movement through the focus point is comparatively time-consuming and should be repeated several times for adequate adjustment accuracy, with the measurement values being averaged.

A third and particularly advantageous method for setting the weighting factor will be described in the following text.

The use of this method is based on the assumption that the objective lens is located in the vicinity of the optimum focus point, and the focus regulator has already been activated. The tracking regulator is likewise already activated, so that the scanning beams scan the predetermined positions, as described above, on the tracks of an optical storage medium.

A disturbance signal S which is produced by a disturbance signal generator DG is fed into the closed focus control loop at an addition point. This disturbance signal S is advantageously sinusoidal and has an amplitude which modulates the operating point of the focus regulator through, for example, 10% of its maximum control range. This results in the focus-error-dependent components of the respective scanning beams being modulated by about 10% of their maximum values. The maximum values are in this case given by the peak-to-peak amplitude of the focus error signal during movement of the objective lens through the focus point. If now, by way of example, the objective lens is moved toward the information layer with disturbance signal modulation, then the focus-error-dependent components of the secondary beams and of the main beam become positive. If the objective lens is moved away from the information layer, then the focus-error-dependent components of the three scanning beams become negative, see FIG. 12.

If the main beam signal with a weighting K′>Kₒₚₜ which has been set too large or the sum of the secondary beam signals with a weighting K which has been set too low are now subtracted from one another, then the focus error component of the main beam signal is not completely compensated for in the subtraction process by the focus error component of the secondary beam sum signal, see FIG. 13A. The output signal after the subtraction process in consequence has a signal component which is in antiphase to the disturbance signal S, the product of the digitized disturbance signal Bin(S) and DFO is negative, and thus has a negative mean value AV, and the output signal INT from the integrator is also negative.

If, on the other hand, the main beam signal with a weighting K′<Kₒₚₜ which has been set too low or the sum of the secondary beam signals with a weighting K which has been set too high are subtracted from one another, then the focus error component of the main beam signal is overcompensated for in the subtraction process by the focus error component of the secondary beam sum signal, see FIG. 13B. The output signal after the subtraction process in this case has a signal component which is in phase with the disturbance signal S.

For both cases, the amplitude after the subtraction process is dependent on the weighting error between the main and secondary beam signals.

The aim is to set the weighting K, K′ such that the amplitude which results from the disturbance signal modulation of the focus regulator and is thus dependent on the focus error tends to zero after the subtraction process.

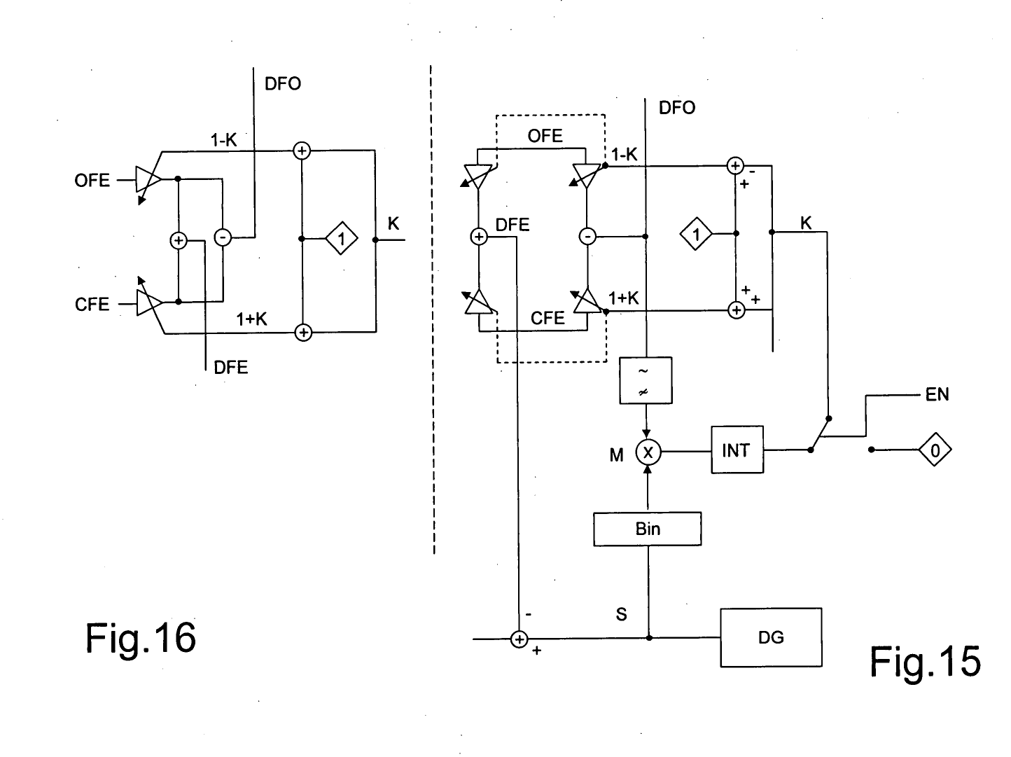

Since the focus-error-dependent signal after the subtraction process has a phase angle which is dependent on the weighting error between the main and secondary beam signals, and since the magnitude of the amplitude of this signal is approximately proportional to the adjustment error of the weighting factor, it is advantageously possible to use a synchronous demodulator for the evaluation process, in order to automatically adjust the weighting factor K, K′. During this process, as an alternative to the use of a weighting factor K for the secondary beam error signals or a weighting factor K′ for the main beam error signals, it is advantageously possible to subdivide the weighting into two weighting factors 1+K, 1−K in the two signal branches, as is shown in the exemplary embodiments in FIGS. 14A-B, FIG. 15 and FIG. 16. This subdivision of the weighting factor results in the amplitude of the signal DFO being less dependent on the setting of the weighting factor.

In a first variant (shown in FIG. 14A), the synchronous demodulator comprises a multiplier M, an averaging unit AV and a control circuit comprising a window comparator WC and an up/down counter UDC for the weighting factor. The multiplier M, which multiplies the output signal DFO from the subtractor as a first measurement signal by the disturbance signal S as a second measurement signal, produces a pulsating DC voltage, whose polarity depends on the phase between the input signals to the multiplier M and whose mean value depends on the magnitude of the amplitude of the output signal DFO from the subtractor. The control circuit for the weighting factor evaluates the polarity of the mean value formed and changes the weighting factor K in steps, in a direction which is derived from the polarity. This is done in a plurality of iterative steps until the magnitude of the mean value is within a predetermined limit value. A window comparator WC is normally used for this purpose, whose comparison voltages +VT, −VT are predetermined. Since the mean value should ideally tend to zero when the weighting K is set correctly, the comparison voltages +VT, −VT should be chosen to be sufficiently small that the optimum weighting factor K is found with sufficient accuracy. Instead of the mean value, it is also as an alternative possible to evaluate the amplitude as a criterion for the correct weighting factor K having been reached. Since the magnitude of the mean value is approximately proportional to the adjustment error of the weighting factor K, it is possible to reduce the number of iterative adjustment steps which lead to the optimum weighting factor. If, from a first comparison step by way of example, the quotient formed in a weighting change unit SSC of the defined weighting change step divided by the mean value change measured in the mean value changing unit AVSM is known, then the next weighting step can be calculated from this in a step calculation unit KSC, as is shown in FIG. 14B, thus reducing the number of steps required to reach the optimum weighting factor K.

In a second variant, see FIG. 15, the synchronous demodulator comprises a multiplier M, an integrator INT and a matching circuit for the weighting factor. In this case, by way of example, the typically sinusoidal disturbance signal S can be digitized as a first measurement signal before the multiplication process in a digitizer Bin, with the outputs of the digitizer being +1 or −1. The multiplier M then multiplies the output signal from the subtractor as the second measurement signal by +1 or −1, with a pulsating DC voltage once again being produced, whose polarity depends on the phase between the input signals of the multiplier M and whose mean value depends on the magnitude of the amplitude of the output signal from the subtractor. The integrator INT, which follows the multiplier, changes its output voltage until the value of the multiplication tends to zero. This is in fact the case when the optimum weighting factor K has been reached. Accordingly, if the output voltage from the integrator INT is connected by means of a matching circuit to the weighting setting, then this results in a control loop which automatically adjusts itself because of the integrator INT in the feedback path such that the input signal to the integrator INT tends to zero.

The weighting factor K can be determined relatively accurately in particular with the aid of the two variants corresponding to the third adjustment method. All of the adjustment methods can advantageously be carried out by digital signal processing or by means of a digital signal processor. Alternatively, two scanning beams are also sufficient to form a signal for track counting, that is to say for example the main beam as well as only one of the secondary beams.

The methods described above for determination of the correct weighting factor can be used for the formation of a signal for track counting, in which case the subtraction of the main beam error signal from the secondary beam sum error signal can be used to compensate for the focus error components.

Subject to the precondition that the ratio between the sensitivities for focus offset components and focus error components is the same for the main beam and for the secondary beams, the weighting factor that is determined can likewise be used to add a secondary beam sum error signal and a main beam error signal to one another with weightings applied, in order to compensate for the focus offset components contained in them and to produce the focus error components (FIG. 16). A correctly set weighting factor then ensures on the one hand that the DFO signal has no focus-error-dependent components, and on the other hand that the DFE signal contains no focus-offset-dependent components. The use of the same weighting factor depends essentially on the characteristics of the optical scanner and on the position Δn of the secondary beams.

The determination of the weighting factor is normally one element within a procedure comprising a plurality of adjustment steps, which are carried out after switching on an appliance for reading from or writing to an optical storage medium. These adjustment steps are carried out, for example, before the start of a reading or writing process.

The advantage of the two variants corresponding to the third adjustment method is that they can likewise be carried out while reading from or writing to an optical storage medium provided that the amplitude of the disturbance signal S injected into the focus control loop is chosen such that the reading or writing process is not interfered with. This can be ensured by maintaining the quality of the reading or writing process despite heating of the appliance, or other influences.

The invention thus relates to the problem that recordable optical discs have a so-called land and groove structure on the basis of a number of already existing or future standards. In this case, information is recorded both on a track (groove) and on the area between two tracks, which is often also referred to as the guard band, mirror area or groove. At least for some types of such recordable discs or optical recording media, there is virtually no difference in the reflectivity between the land areas and groove areas, at least before they have been written to. When a track jump takes place, moving away over such areas that have not been written to, it is thus not easy, or may even be completely impossible, to correctly count the number of tracks crossed over. The invention proposes that the signals which are generated in order to carry out the differential focusing method (which is also referred to as the differential astigmatism method) additionally be used to generate a signal which indicates whether the scanning beam is currently scanning a land track or a groove track. During a track jump, this signal is then used to count the number of tracks crossed over. According to the differential focusing method, focusing error signals are produced, according to the astigmatism method, both for the main beam and for the secondary beam or beams of a three-beam scanning system. The weighted sum of these signals forms the differential focusing error signal, which is independent of errors which are produced by different offsets for the land track and groove track. According to the invention, a weighted difference between these signals is additionally generated. This difference signal includes no components, or virtually no components, of the focusing error signal, but indicates the actual offset value. Since the actual offset value depends on the type of track currently being scanned, that is to say a land track or groove track, this signal indicates whether a land track or a groove track is currently being scanned. The signal according to the invention is independent of the difference between the reflectivity of the land tracks and groove tracks, since it is based on signals from which the focusing error signal is obtained, which is independent of the status of the track currently being scanned, either written to or not having been written to, but depends only on the track type, that is to say a land track or groove track. No additional hardware is required for the appliance according to the invention, all that is required being a number of logic elements for evaluation of the signals according to the invention.

1. An appliance for reading from and/or writing to optical recording media, wherein signals which are required for carrying out differential focusing methods also are used for generation of a land groove detection signal.

2. A method for generating a track type signal in a scanning unit for optical recording media having data stored in tracks, with the scanning unit having an objective lens and a focus control loop, producing an optical main beam and at least one secondary beam, evaluating light reflected from the recording medium with a plurality of photodetector segments which are associated with the beams, deriving a first error signal from the signals of the photodetector segments associated with the main beam and deriving a second error signal from the signals of the photodetector segments associated with the secondary beams, comprising:
scanning of the optical recording medium with deflection of the objective lens in focus direction;
measurement of two measurement signals which are formed differently and contain details about the distance of the objective lens relative to the recording medium and about the position of the scanning beam relative to the tracks on the recording medium;
evaluation of the measurement signals;
setting of branch weights controlled by the result of the evaluation;
formation of the track type signal by combination of the first error signal multiplied by a first of the branch weights and of the second error signal multiplied by a second of the branch weights.

3. The method as claimed in claim 2, which is used with the focus control loop switched on, with the objective lens being deflected by feeding a disturbance signal into the focus control loop, a track error component contained in the error signals and caused by the disturbance signal being extracted, and the correct setting of the branch weights being determined from the phase angle and the amplitude of the track error component.

4. The method as claimed in claim 3, with the first measurement signal being formed from the disturbance signal and the second measurement signal being formed from the difference between the first error signal and the second error signal in order to extract the track error component, and the product of the measurement signals being evaluated as the evaluation signal.

5. The method as claimed in claim 4, with the evaluation signal being evaluated by averaging or integration.

6. The method as claimed in claim 2, in which the objective lens is deflected by moving it toward the recording medium with the focus control loop open.

7. The method as claimed in claim 6, in which the first measurement signal is formed from the first error signal, the second measurement signal is formed from the second error signal, the amplitudes of the measurement signals are evaluated, and the branch weights are calculated from the measured amplitudes such that the difference between the error signals multiplied by the branch weights disappears.

8. The method as claimed in claim 6, in which the first measurement signal is formed from the first error signal multiplied by the first branch weight, the second measurement signal is formed from the second error signal multiplied by the second branch weight the amplitudes of the measurement signals are evaluated and, if there are any differences between the amplitudes, the branch weights are changed in at least one adjustment step such that the difference between the amplitudes is reduced.

9. The method as claimed in claim 3, with the magnitude of the change to the branch weights in an adjustment step being determined as a function of the value of the evaluation signal in a previous adjustment step.

10. The method as claimed in claim 2, with signals which are involved being normalized with respect to the sum of the individual signals on which they are each based.

11. An apparatus for carrying out one of the methods as claimed in claim 2.
